(19) United States
(12) Patent Application Publication
(10) Pub. No.: US 2025/0178894 A1
(43) Pub. Date: Jun. 5, 2025

(54) SYSTEMS AND METHODS FOR ELECTRICAL RESISTANCE HEATING OF COMPOSITE CATALYSTS

(71) Applicants: Saudi Arabian Oil Company, Dhahran (SA); CoorsTek Membrane Sciences AS, Oslo (NO)

(72) Inventors: Aadesh Harale, Dhahran (SA); Aqil Jamal, Dhahran (SA); Selene Hernandez Morejudo, Oslo (NO); Xin Liu, Oslo (NO); Per Vestre, Oslo (NO)

(21) Appl. No.: 18/528,074

(22) Filed: Dec. 4, 2023

(51) Int. Cl. C01B 3/34; B01J 8/18; B01J 23/00; B01J 23/83; B01J 35/30; B01J 35/55; B01J 35/57; B01J 35/61; C01B 3/40; C01B 32/40

(52) U.S. Cl. CPC C01B 3/342; B01J 8/1836; B01J 23/002; B01J 23/83; B01J 35/392; B01J 35/394; B01J 35/55; B01J 35/57; C01B 3/40; C01B 32/40; B01J 35/613; B01J 35/615; B01J 2208/00415; B01J 2523/25; B01J 2523/36; B01J 2523/3712; B01J 2523/48; C01B 2203/0233; C01B 2203/085; C01B 2203/1058; C01B 2203/1082; C01B 2203/1241

(57) ABSTRACT

The disclosure relates to systems and methods in which composite catalysts are heated with electrical-resistance heating. The composite catalysts include a catalytically active phase and a porous metal oxide.

### FIELD

The disclosure relates to systems and methods in which composite catalysts are heated with electrical-resistance heating. The composite catalysts include a catalytically active phase and a porous metal oxide.

### BACKGROUND

In certain reformer plant designs, the heat source is placed at the outer reactor shell and the catalyst is inside the reactor shell. The heat then transfers through the reactor shell to the catalyst. When such systems are used for endothermic reactions, thermal conduction can be the rate-limiting step.

### SUMMARY

The disclosure relates to systems and methods in which composite catalysts are heated with electrical-resistance heating. The composite catalysts include a catalytically active phase and a porous metal oxide.

The systems and methods can enhance the speed of heat transfer, reduce temperature gradients (e.g., axial temperature gradients and/or temperature gradients along the direction of the flow of a reactant gas stream), and/or reduce uneven distribution of reactions within the flow path relative to certain other systems and methods, such as those that include a catalyst within a reactor shell that is externally heated. The systems and methods can provide more efficient heating and heat transfer thereby providing lower overall temperature gradients across the catalyst and heat source, reduced reaction volumes, improved product yield over the catalyst volume (improved catalyst effectiveness factors), greater control over the location of heating, and/or reduced costs associated with materials and heating. Using the systems and methods according to the disclosure, the temperature of the composite catalyst can be controlled more precisely relative to certain other systems and methods. The systems and method can reduce heat loss and/or reduce temperature differences relative to certain other heating methods such as systems and methods than heat through radiative or conductive heating.

Without wishing to be bound by theory, it is believed that when using the systems and methods according to the disclosure, the heat is directly generated on the composite catalyst. The composite catalyst can be heated (e.g., directly heated) without an external heat source or heat transfer to the composite catalyst. The generated heat is generated directly in the catalytically active phase and supplied to endothermic reactions. Without wishing to be bound by theory, it is believed that the systems and methods can enhance heat transfer and hydrogen yields in various reactions, including, for example, steam methane reforming and ammonia decomposition.

Without wishing to be bound by theory, it is believed that the macroscopic structure and geometry of the composite catalyst allows both electrical current and gas flow to be relatively evenly distributed, yielding a relatively uniform resistance-heating over the composite catalyst region. Additionally, without wishing to be bound by theory, it is believed that structure of the composite catalyst allows for direct heat generation on the active sites of the composite catalyst, facilitating relatively high catalytic performance, relatively even heat distribution, and relatively fast heating.

The systems and methods can be integrated with renewable electricity and energy sources.

In a first aspect, the disclosure provides a system, including: a composite catalyst including a porous metal oxide and a catalytically active phase supported by the porous metal oxide, and a power source configured to heat the composite catalyst by electrical resistance heating.

In some embodiments, the catalytically active phase is homogeneously distributed in the porous metal oxide.

In some embodiments, the catalytically active phase includes Ni, Ru, Fe, Pt, and/or Pd.

In some embodiments, the porous metal oxide includes Y-doped BaZrO₃; Y-doped BaCeO₃; AZrₐCe_{b}B_{c}O_{3-δ}, wherein A is Ba, Sr, or Ca; B is Y, Yb, Pr, Gd, Fe, Co, Ni, Cu, or Zn; a+b+c equals 1; b is 0-0.95; c is 0.05-0.5; and δ is a number such that formula is uncharged; and/or XₐM1M2Oₓ, wherein M1 and M2 are Al, Si, Zr, Ce, Ti or Mg; M2 is different from M1; X is K, Ca or B; a is 0-1; and x is nonstoichiometric and can vary under different conditions.

In some embodiments, the porous metal oxide includes BaZr_{0.7}Ce_{0.2}Y_{0.1}O₃₋₈.

In some embodiments, the composite catalyst includes Ni/BaZr_{0.7}Ce_{0.2}Y_{0.1}O_{3-δ}.

In some embodiments, the composite catalyst has a porosity of 20% to 70%.

In some embodiments, the composite catalyst has a total surface area of 20 m²/g to 100 m²/g.

In some embodiments, the catalytically active phase has a surface area of 1 m²/g to 20 m²/g.

In some embodiments, the catalytically active phase includes nanoclusters and/or nanoparticles.

In some embodiments, the composite catalyst includes 30 wt. % to 70 wt. % of the catalytically active phase.

In some embodiments, the composite catalyst includes a tubular structure. In some embodiments, the system further includes an inlet configured to deliver a gas to an interior space of the tubular structure.

In some embodiments, the composite catalyst includes a honeycomb structure with a plurality of parallel channels. In some embodiments, the honeycomb structure includes a first face and a second face. A first portion of the parallel channels are sealed at the first face, a second portion of the parallel channels are sealed at the second face, and the second portion of the parallel channels is different from the first portion of the parallel channels.

In some embodiments, the system further includes a pressure vessel and an insulation material. The composite catalyst is disposed inside the pressure vessel and the insulation material is between the pressure vessel and the composite catalyst.

In a second aspect, the disclosure provides a reformer plant including a system of the disclosure. In certain embodiments, the reformer plant further includes a membrane gas separation unit in fluid communication with an output of the system.

In a third aspect, the disclosure provides a method including: applying a current to a composite catalyst, thereby heating the composite catalyst; contacting the heated composite catalyst with a first gas stream; and forming a second gas stream. The composite catalyst includes a porous metal oxide and an active phase supported by the porous metal oxide.

In certain embodiments, the first gas stream includes methane and water, and the second gas stream includes hydrogen and carbon monoxide.

### BRIEF DESCRIPTION OF THE FIGURES

FIG. 1 depicts a schematic of a system used in a steam methane reforming reaction.

FIG. 2 depicts a schematic of a system used in a steam methane reforming reaction.

FIG. 3A depicts a schematic of a honeycomb monolith composite catalyst.

FIG. 3B depicts a zoom in of a portion of a honeycomb monolith composite catalyst.

FIG. 3C depicts an SEM image of a honeycomb monolith composite catalyst.

FIG. 4 depicts a schematic of a honeycomb monolith composite catalyst.

FIG. 5 depicts a schematic of a system used in a steam methane reforming reaction with an energy source.

FIG. 6 depicts an illustration of an experimental set up.

FIG. 7 shows a graph of temperature as a function of time as a current is applied to a composite catalyst.

FIG. 8 shows a graph of methane conversion in a steam methane reforming reaction as a function of temperature.

FIG. 9 depicts currents and voltages used in steam methane reforming reactions.

FIG. 10 shows a graph of methane conversion in a steam methane reforming reaction as a function of temperature.

### DETAILED DESCRIPTION

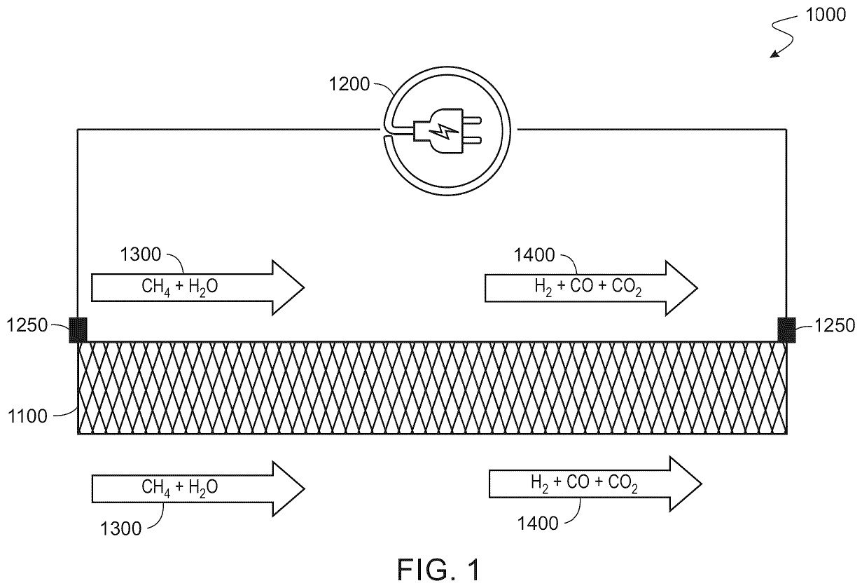

FIG. 1 depicts a schematic of a system 1000 used in a steam methane reforming reaction. The system includes a composite catalyst 1100 and a power source 1200. The composite catalyst 1100 is electrically conducting. A pair of electrical contacts 1250 positioned on an external surface of the composite catalyst 1100 provide electrical communication between the composite catalyst 1100 and the power source 1200. The power source 1200 is configured to heat the composite catalyst 1100 with electric resistance-heating by supplying an electric current to the composite catalyst 1100.

A reactant gas stream 1300 including methane (CH₄) and water (H₂O) contacts the heated composite catalyst 1100. At least a portion of the CH₄ and H₂O in the reactant gas stream 1300 are converted into hydrogen (H₂) and carbon monoxide (CO) due to the interaction of the reactant gas stream 1300 with the heated composite catalyst 1100. In some embodiments, carbon dioxide (CO₂) is also produced. The gases produced from the conversion of CH₄ and H₂O form a product gas stream 1400 that includes H₂ and CO, and optionally CO₂.

The composite catalyst 1100 includes a catalytically active phase and a porous metal oxide. The porous metal oxide acts as a support for the catalytically active phase with at least a portion of the catalytically active phase constrained in the macrostructure of the porous metal oxide. In some embodiments, at least a portion of the catalytically active phase may be supported on a surface of the porous metal oxide. Without wishing to be bound by theory, it is believed that the porous metal oxide improves the dispersion of the catalytically active phase relative to the situation where the porous metal phase is not present, thereby increasing the surface area of the catalytically active phase and enhancing the catalytic properties of the catalytically active phase. In some embodiments, the catalytically active phase is homogenously distributed within the macrostructure of the porous metal oxide.

Without wishing to be bound by theory, it is believed that the catalytically active phase is an electrically conducting phase of the composite catalyst 1100, and that applying an electrical current to the catalytically active phase directly heats the catalytically active phase to provide the heat used in the endothermic reaction.

Without wishing to be bound by theory, it is believed that heat is generated on the catalytically active phase itself without an additional layer to enhance heat transfer. The metal oxide acts as a support material, rather than for heat generation and transfer purposes.

In general, it is desirable for the catalytically active phase and the porous metal oxide to be thermally stable to reduce (e.g., prevent) sintering and/or deformation of the composite catalyst 1100 over time. Additionally, in general, it is desirable for the catalytically active phase and the porous metal oxide to have sufficient mechanical strength to withstand relatively high temperatures and relatively high pressures. Further, in general, it is desirable for the catalytically active phase and the porous metal oxide to be relatively stable at relatively high temperatures (e.g., at least 350° C. and/or at most 1000° C.) in the presence of certain gases, such as methane, water, ammonia, and hydrogen. In addition, in general, it is desirable for the composite catalyst 1100 to have a relatively long operational life under the desired reaction conditions.

While FIG. 1 depicts the composite catalyst 1100 being used for steam methane reforming, in general any endothermic reaction for the generation of hydrogen using an appropriate reactant can be performed. In general, the catalytically active phase can be selected based on the desired reaction. For example, the system 1000 can be used for ammonia decomposition, dry reforming, ethane reforming, methanol steam reforming and/or ethanol steam reforming.

In general, the composition of the catalytically active phase and the amount of the catalytically active phase present in the composite catalyst 1100 can be tailored based on the desired reaction and reaction conditions. The catalytically active phase can include one or more known catalyst for the reaction of interest (e.g., steam methane reforming, ammonia decomposition, dry reforming, ethane reforming, methanol steam reforming, ethanol steam reforming). Examples of catalytically active phases that may be used include nickel, ruthenium, iron, cobalt, platinum, and palladium. Without wishing to be bound by theory, it is believed that the ratio of the catalytically active phase to porous metal oxide can control the resistance, where increasing the amount of porous metal oxide increase the resistance.

In some embodiments, the catalytically active phase is disposed on the porous metal oxide as nanoclusters and/or nanoparticles. In some embodiments, the nanoclusters and/or nanoparticles have a maximum dimension (e.g., diameter) of at least 1 (e.g., at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) nm and/or at most 100 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5, at most 4, at most 3, at most 2) nm. Without wishing to be bound by theory, it is believed that the relatively small size of the catalytically active phase as nanoclusters or nanoparticles offers higher surface area per unit volume compared to larger particles. This increased surface area can provide more active sites for chemical reactions to occur, which can enhance the catalytic activity of the composite catalyst 1100.

In general, it is desirable for the porous metal oxide to be sufficiently porous to increase the surface area of the catalytically active phase, the reactant diffusion and/or dispersion of the catalytically active phase. This means that the composite catalyst 1100 also would be relatively porous and would have a relatively high total surface area because these properties for the composite catalyst 1100 are derived from the corresponding properties of the porous metal oxide. In some embodiments, the composite catalyst 1100 has a porosity by fluid saturation method of at least 20 (e.g., at least 25, at least 30, at least 35, at least 40, at least 45, at least 50, at least 55, at least 60, at least 65) % and/or at most 70 (e.g., at most 65, at most 60, at most 55, at most 50, at most 45, at most 40, at most 35, at most 30, at most 25) %. In some embodiments, the composite catalyst 1100 has a total surface area of at least 20 (e.g., at least 25, at least 30, at least 35, at least 40, at least 45, at least 50, at least 55, at least 60, at least 65, at least 70, at least 75, at least 80, at least 85, at least 90, at least 95) square meters per gram (m²/g) and/or at most 100 (e.g., at most 95, at most 90, at most 85, at most 80, at most 75, at most 70, at most 65, at most 60, at most 55, at most 50, at most 45, at most 40, at most 35, at most 30, at most 25) m²/g. In some embodiments, the surface area by N₂ physisorption BET of the catalytically active phase is at least 1 (e.g., at least 2, at least 3, at least 4, at least 5, at least 6, at least 7, at least 8, at least 9, at least 10, at least 11, at least 12, at least 13, at least 14, at least 15, at least 16, at least 17, at least 18, at least 19) m²/g and/or at most 20 (e.g., at most 19, at most 18, at most 17, at most 16, at most 15, at most 14, at most 13, at most 12, at most 11, at most 10, at most 9, at most 8, at most 7, at most 6, at most 5, at most 4, at most 3, at most 2) m²/g.

In some embodiments, the porous metal oxide has a porosity by fluid saturation method of at least 20 (e.g., at least 25, at least 30, at least 35, at least 40, at least 45, at least 50, at least 55, at least 60, at least 65) % and/or at most 70 (e.g., at most 65, at most 60, at most 55, at most 50, at most 45, at most 40, at most 35, at most 30, at most 25) %. In some embodiments, the porous metal oxide has a total surface area of at least 20 (e.g., at least 25, at least 30, at least 35, at least 40, at least 45, at least 50, at least 55, at least 60, at least 65, at least 70, at least 75, at least 80, at least 85, at least 90, at least 95) m²/g and/or at most 100 (e.g., at most 95, at most 90, at most 85, at most 80, at most 75, at most 70, at most 65, at most 60, at most 55, at most 50, at most 45, at most 40, at most 35, at most 30, at most 25) m²/g.

In some embodiments, the porous metal oxide includes Y-doped BaZrO₃ and/or Y-doped BaCeO₃. In some embodiments, the porous metal oxide is AZrₐCe_{b}B_{c}O_{3-δ}; wherein A is Ba, Sr, or Ca; B is Y, Yb, Pr, Gd, Fe, Co, Ni, Cu, or Zn; a+b+c equals 1; b is 0-0.95; c is 0.05-0.5; and δ is a number such that formula is uncharged (e.g., δ is 2.75≤8≤2.95). In some embodiments, the porous metal oxide is XₐM1M2Oₓ; wherein M1 and M2 are Al, Si, Zr, Ce, Ti or Mg; M2 is different from M1; X is K, Ca or B; a is 0-1; and x is nonstoichiometric and can vary under different conditions. In some embodiments, the porous metal oxide is BaZr_{0.7}Ce_{0.2}Y_{0.1}O_{3-δ}. In some embodiments, the composite catalyst 1100 is Ni/BaZr_{0.7}Ce_{0.2}Y_{0.1}O_{3-δ}. In these formula, δ is a number such that formula is uncharged.

Without wishing to be bound by theory, it is believed that the porous metal oxide (e.g., BaZr_{0.7}Ce_{0.2}Y_{0.1}O_{3-δ}) provides relatively high dispersion for the catalytically active material. It is also believed that, in the case of steam reforming reactions, the high dispersion of the catalytically active material can enhance steam activation (e.g., by adsorption of water in active sites) and suppress carbon deposition (e.g., coke deposition on the composite catalyst 1100). Without wishing to be bound by theory, it is believed that coke formation can deactivate the catalytically active phase of the composite catalyst 1100 and reduce the catalytic performance of the composite catalyst 1100, thereby reducing the efficiency of the process. It is also believed that the porous metal oxide support can play a role inhibiting coke formation. The porous metal oxide has a high surface area, which provides more active sites for the catalytic reactions, allowing for relatively high dispersion of active metal catalyst particles, and reducing the formation of relatively large carbon deposits. In addition, the composition of the porous metal oxide support and/or promoters or dopants added to the porous metal oxide can promote the catalytic activity of the catalytically active phase while inhibiting coke formation.

In general, the composite catalyst 1100 can include any appropriate amount of the catalytically active phase. In certain embodiments, the composite catalyst 1100 includes at least 30 (e.g., at least 35, at least 40, at least 45, at least 50, at least 55, at least 60, at least 65) wt. % and/or at most 70 (e.g., at most 65, at most 60, at most 55, at most 50, at most 45, at most 40, at most 35) wt. % of the catalytically active phase.

In general, the composite catalyst 1100 can include any appropriate amount of the porous metal oxide. In certain embodiments, the composite catalyst 1110 includes at least 30 (e.g., at least 35, at least 40, at least 45, at least 50, at least 55, at least 60, at least 65) wt. % and/or at most 70 (e.g., at most 65, at most 60, at most 55, at most 50, at most 45, at most 40, at most 35) wt. % of the porous metal oxide.

Without wishing to be bound by theory, is believed that the temperature of the composite catalyst 1100 can controlled by the electrical current. In general, the composite catalyst 1100 can be heated to any appropriate temperature. In some embodiments, the composite catalyst 1100 is heated to a temperature of at least 350 (e.g., at least 400, at least 450, at least 500, at least 550, at least 600, at least 650, at least 700, at least 750, at least 800, at least 850, at least 900, at least 950° C.) and/or at most 1000 (e.g., at most 950, at most 900, at most 850, at most 800, at most 750, at most 700, at most 650, at most 600, at most 550, at most 500, at most 450, and most 400)° C.

In general, a direct current is supplied by the power source 1200. The current can be selected based on, for example, the dimensions of the composite catalyst 1100 and the target temperature. In certain embodiments, the current passing through to the composite catalyst 1100 is at least 10 (e.g., at least 15, at least 20, at least 25, at least 30, at least 35, at least 40, at least 45, at least 50, at least 55, at least 60, at least 65, at least 70, at least 75) Amperes (A) and/or at most 80 (e.g., at most 75, at most 70, at most 65, at most 60, at most 55, at most 50, at most 45, at most 40, at most 35, at most 30, at most 25, at most 20, at most 15) A. In certain embodiments, more than one power source 1200 (e.g., two, three, four, five, ten) can be used in parallel to increase the total current.

In some embodiments, the system 1000 further includes a pressure vessel that holds the composite catalyst 1100. The pressure vessel is used to maintain the pressure of the reactor and control the gas flow through the composite catalyst 1100. In such embodiments, heat and/or electrical insulation is present between the pressure vessel and the composite catalyst 1100. In general, the electrical insulation material can be any suitable material. Examples of the electrical insulation material include glass and ceramics. In some embodiments, the heat and/or electrical insulation is applied by spray or wash coating.

In certain embodiments, the pressure of the reactant gas stream 1300 is at least 1 (e.g., at least 2, at least 3, at least 4, at least 5, at least 6, at least 7, at least 8, at least 9, at least 10, at least 15, at least 20, at least 25, at least 30, at least 35) bar and/or at most 40 (e.g., at most 35, and most 30, at most 25, at most 20, at most 15, at most 10, at most 9, at most 8, at most 7, at most 6, at most 5, at most 4, at most 3, at most 2) bar.

In some embodiments, the composite catalyst 1100 has a tubular or honeycomb structure. In such embodiments, the composite catalyst 1100 includes one or more channels. In general, the composite catalyst 1100 can be extruded into any desired geometry. For example, the composite catalyst 1100 can be extruded into a tubular shape or a honeycomb monolith. Such structures can enhance contact between the reactant gas stream 1300 and the composite catalyst 1100 and provide more uniform flow distributions.

Without wishing to be bound by theory, it is believed that the composite catalyst 1100 can be fabricated by extrusion to a relatively uniform geometry. In general, the die of the extrusion process can be selected based on the desired shape (e.g., tubular, honeycomb), desired dimensions, and cell density. In certain embodiments, the composite catalysts 1100 are extruded with at least 20 (e.g., at least 30, at least 40, at least 50, at least 60, at least 70, at least 80, at least 90, at least 100, at least 150, at least 200, at least 250, at least 300, at least 350, at least 400, at least 450) cells per square inch (cpsi) and/or at most 500 (e.g., at most 450, at most 400, at most 350, at most 300, at most 250, at most 200, at most 150, at most 100, at most 90, at most 80, at most 70, at most 60, at most 50, at most 40, at most 30) cpsi.

After extrusion, the composite catalyst 1100 can be dried then fired (e.g., hangfired). The drying can be performed in air at room temperature while the composite catalyst 1100 is rotated. In some embodiments, the drying is performed at a temperature of at least 20 (e.g., at least 25, at least 30, at least 35, at least 40, at least 45, at least 50, at least 55, at least 60, at least 65, at least 70, at least 75° C.) and/or at most 80 (e.g., at most 75, at most 70, at most 65, at most 60, at most 55, at most 50, at most 45, at most 40, at most 35, at most 30, at most 25° C.) In some embodiments, the drying is performed for a duration of at least 0.5 (e.g., at least 1, at least 2, at least 3, at least 4, at least 5, at least 6, at least 7, at least 8, at least 9, at least 10, at least 12, at least 14, at least 16, at least 18, at least 20, at least 22) hours and/or at most 24 (e.g., at most 22, at most 20, at most 18, at most 16, at most 14, at most 12, at most 10, at most 9, at most 8, at most 7, at most 6, at most 5, at most 4, at most 3, at most 2, at most 1) hours. In some embodiments, the firing (e.g., hangfiring) is performed at a temperature of at least 1550 (e.g., at least 1560, at least 1570, at least 1580, at least 1590, at least 1600, at least 1610, at least 1620, at least 1630, at least 1640° C.) and/or at most 1650 (e.g., at most 1640, at most 1630, at most 1620, at most 1610, at most 1600, at most 1590, at most 1580, at most 1570, at most 1560° C.) In some embodiments, the firing (e.g., hangfiring) is performed for a duration of at least 5 (e.g., at least 6, at least 7, at least 8, at least 9, at least 10, at least 11, at least 12, at least 13, at least 14) hours and/or at most 15 (e.g., at most 14, at most 13, at most 12, at most 11, most 10, at most 9, at most 8, and most 7, at most 6) hours.

Prior to use, the composite catalyst 1100 can be reduced. In some embodiments, the reduction can be performed at a temperature of 400° C. for 5 hours. In some embodiment, the reduction can be performed in 5% H₂ in argon.

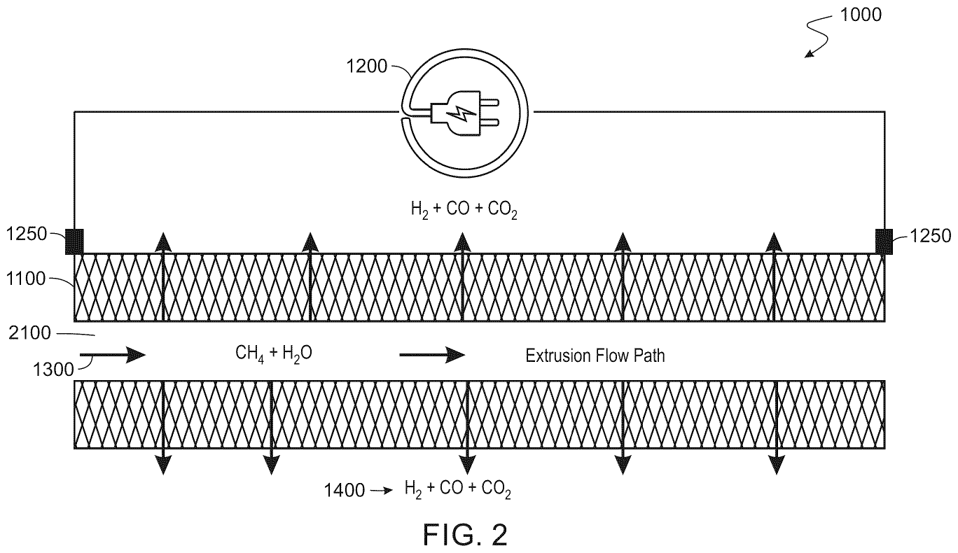

FIG. 2 depicts a schematic of a system 2000 used in a steam methane reforming reaction. The system 2000 includes the composite catalyst 1100, the power source 1200, the electrical contacts 1250, the reactant gas stream 1300 and the product gas stream 1400. In the system 2000, the composite catalyst 1100 includes a channel 2100 through which the reactant gas stream 1300 is flowed. The composite catalyst 1100 has a porous microstructure that includes pores. The CH₄ and H₂O can pass through pores within the structure of the composite catalyst 1100 and form H₂, CO, and/or CO₂. The generated H₂, CO, and/or CO₂ can exit the pores within the structure of the composite catalyst 1100 to a space external to the composite catalyst 1100. In general, the conditions (e.g., pressure, temperature, composition of the reactant gas stream 1300) for the system 2000 can be the same as those noted above for the system 1000.

In general, the dimensions of the composite catalyst 1100 are influenced by the shape of the composite catalyst 1100. In certain embodiments, when the composite catalyst 1100 has a tubular structure, the composite catalyst 1100 has a length of at least 5 (e.g., at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) cm and/or at most 100 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10) cm. In certain embodiments, when the composite catalyst 1100 has a tubular structure, the composite catalyst 1100 has a maximum outer length (e.g., diameter) of at least 0.4 (e.g., at least 0.5, at least 0.6, at least 0.7, at least 0.8, at least 0.9, at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19) cm and/or at most 20 (e.g., at most 19, at most 18, at most 17, at most 16, at most 15, at most 14, at most 13, at most 12, at most 11, at most 10, at most 9, at most 8, at most 7, at most 6, at most 5, at most 4, at most 3, at most 2, at most 1, at most 0.9, at most 0.8, at most 0.7, at most 0.6) cm.

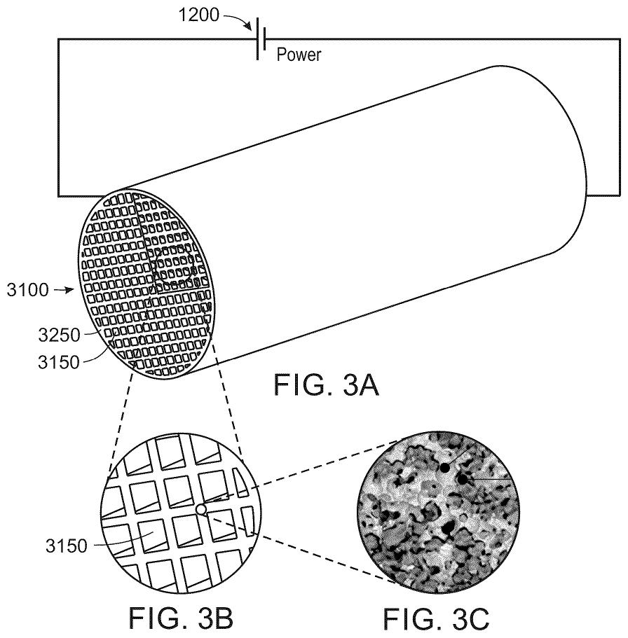

FIG. 3A depicts a schematic of a system 3000 that includes a honeycomb monolith composite catalyst 3100. The honeycomb monolith composite catalyst 3100 is a composite catalyst that includes the catalytically active phase and the porous metal oxide. The honeycomb monolith composite catalyst 3100 includes a plurality of parallel channels 3150. The system 3000 includes the power source 1200 and electrical contacts 3250, which are configured to heat the honeycomb monolith composite catalyst 3100 with electric resistance-heating by supplying an electric current to the honeycomb monolith composite catalyst 3100. An electrical contact 3250 is disposed at each end of the honeycomb monolith composite catalyst 3100 to help ensure relatively uniform distribution of electrical current within and across the honeycomb monolith composite catalyst 3100. FIG. 3B depicts a zoom in of a portion of the honeycomb monolith composite catalyst 3100, to enhance visualization of parallel channels 3150. FIG. 3C depicts an SEM image of the honeycomb monolith composite catalyst 3100 to allow for visualization of the structure of the porous metal oxide. Without wishing to be bound by theory, it is believed that the white component is porous metal oxide, and the dark grey component is Ni, which is the catalytic active phase.

In certain embodiments, the honeycomb monolith composite catalyst 3100 has a length of at least 5 (e.g., at least 10, at least 15, at least 20, at least 25, at least 30, at least 35, at least 40, at least 45) cm and/or at most 50 (e.g., at most 45, at most 40, at most 35, at most 30, at most 25, at most 20, at most 15, at most 10) cm. In certain embodiments, the honeycomb monolith composite catalyst 3100 has a maximum outer length (e.g., diameter) of at least 2 (e.g., at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 22, at least 24, at least 26, at least 28, at least 30, at least 32, at least 34, at least 36, at least 38, at least 40, at least 42, at least 44, at least 46, at least 48) cm and/or at most 50 (e.g., at most 48, at most 46, at most 44, at most 42, at most 40, at most 38, at most 36, at most 34, at most 32, at most 30, at most 28, at most 26, at most 24, at most 22, at most 20, at most 19, at most 18, at most 17, at most 16, at most 15, at most 14, at most 13, at most 12, at most 11, at most 10, at most 9, at most 8, at most 7, at most 6, at most 5, at most 4, at most 3) cm. In certain embodiments, the channels 3150 of the honeycomb monolith composite catalyst 3100 have a maximum outer length (e.g., diameter) of at least 1 (e.g., at least 2, at least 3, at least 4, at least 5, at least 6, at least 7, at least 8, at least 9) mm and/or at most 10 (e.g., at most 9, at most 8, at most 7, at most 6, at most 5, at most 4, at most 3, at most 2) mm.

Generally, the electrical contacts 1250 and 3250 can include any electrically conductive material. Examples of electrically conductive materials include silver, iron, and copper. In some embodiments, the electrical contacts 1250 and 3250 are applied by spray or wash coating. More generally, however, any appropriate method can be used to form the electrical contacts 1250 and 3250 on the catalyst.

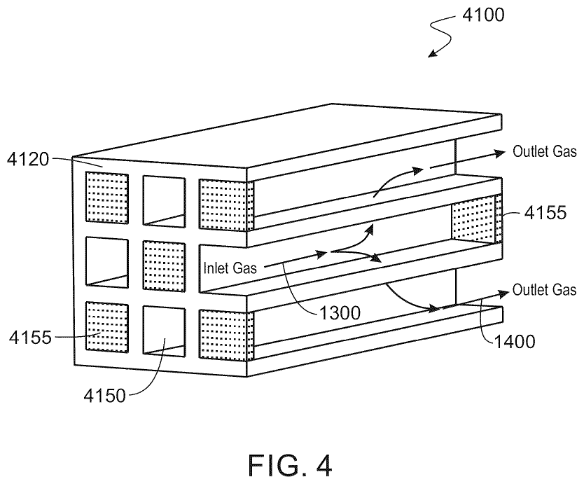

FIG. 4 depicts a schematic of a honeycomb monolith composite catalyst 4100. The honeycomb monolith composite catalyst 4100 is a composite catalyst that includes the catalytically active phase and the porous metal oxide. The honeycomb monolith composite catalyst 4100 includes a plurality of parallel channels 4150. The parallel channels 4150 are alternatively plugged at each end with plugs 4155 to help force the reactant gas stream 1300 to flow through the inner porous walls of the honeycomb monolith composite catalyst 4100. Without wishing to be bound by theory, it is believed that such a configuration enhances contact between the reactant gas stream and the catalytically active phase, resulting in higher catalytic performance relative to certain other honeycomb configurations at the same temperature and gas hourly space velocity (GHSV).

Examples of the materials for the plugs 4155 include glass and ceramic. The plugs 4155 should be selected such that its properties are compatible with the thermal expansion of the honeycomb monolith composite catalyst 4100. The plugs 4155 should be gas tight with minimal (e.g., no) gas permeation to force the reactant gases through the walls of the honeycomb monolith composite catalyst 4100.

Generally, the parallel channels 3150 and 4150 in the honeycomb structure of the honeycomb monolith composite catalyst 3100 and 4100 can be any shape desired. In some embodiments, the parallel channels 3150 and 4150 in the honeycomb structure of the honeycomb monolith composite catalyst 3100 and 4100 can be square, triangular, and/or hexagonal. Without wishing to be bound by a theory, it is believed that such structures of the composite catalyst allow for the electrical current to be distributed relatively evenly, thereby generating heat relatively uniformly over the honeycomb monolith composite catalyst 3100 and 4100. Additionally, the honeycomb structure of the honeycomb monolith composite catalyst 3100 and 4100 can be tailored to allow for precise control over the residence times of the reactant gases. Without wishing to be bound by theory, it is believed that controlling the residence time of the reactants can influence reaction outcomes, reduce pressure drops throughout the structure, and minimize energy consumption.

In some embodiments, the honeycomb structures disclosed herein can be in the form of a module, which allows for flexible reactor design. The modules can be placed, for example, in a pressure vessel. Multiple different honeycomb modules can be arranged and connected in different configurations based on the design to optimize for specific reactions and production scales. In certain embodiments, the honeycomb structure has a unit volume of at least 1 (e.g., at least 2, at least 3, at least 4, at least 5, at least 6, at least 7, at least 8, at least 9) cubic meters (m³) and/or at most 10 (e.g., at most 9, at most 8, at most 7, at most 6, at most 5, at most 4, at most 3, at most 2) m³. Without wishing to be bound by theory, it is believed that a 1140 m³ side-fired reformer producing 2230 killimoles of hydrogen per hour (kmol H₂/h) could be replaced with a reactor unit including a honeycomb catalyst heated by resistance-heating with a unit volume of less than 5 m³.

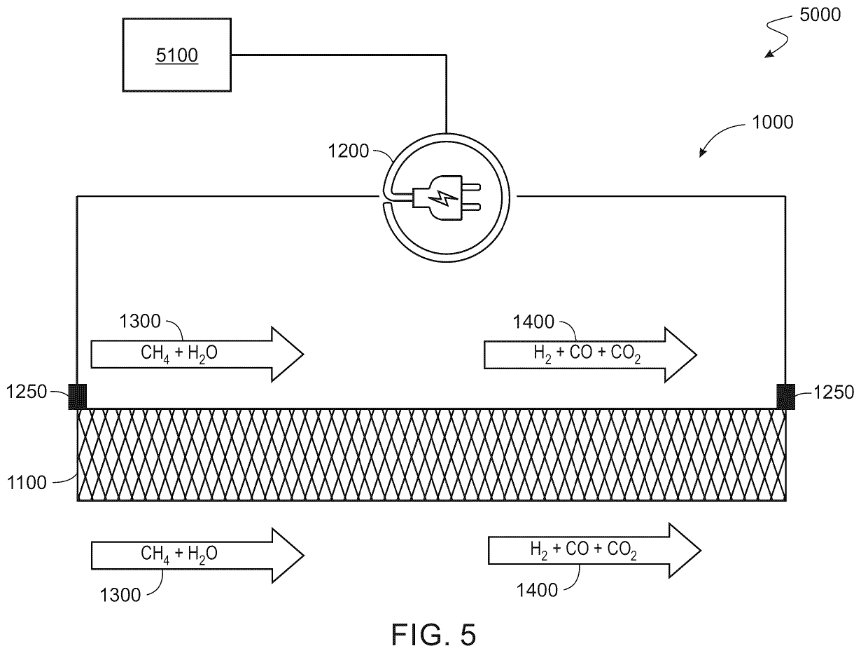

FIG. 5 depicts a schematic of a system 5000. The system 5000 includes the components of the system 1000 as well as an energy source 5100 that provides electricity to the power source 1200. The energy source can be a renewable energy source (e.g., a solar panel, a wind turbine).

The system 1000 and/or 2000 can be integrated with other temperature sensitive technologies in the same unit, such as a component for gas separation (e.g., a membrane gas separation unit).

In certain embodiments, system 1000 and/or 2000 can be integrated into a reformer plant. The reformer usually uses relatively high temperatures (e.g., >700° C.); however, the membrane separation unit may not be able to tolerate such temperatures (e.g., the membrane separation unit may only be able to tolerate temperature of at most 550° C.). In the system 1000 and/or 2000, the heat can be supplied locally, thus making it possible to prevent excessive heating of a gas separation unit.

### EXAMPLES

A tubular Ni/BaZr_{0.7}Ce_{0.2}Y_{0.1}O_{3-δ} catalyst was prepared by extrusion using a Loomis piston extruder with a hydraulic pressure for extrusion of 110 bara and extrusion rate of 0.1 mm/s. The extrudate included of a mixture of ceramic powder and an aqueous binder system. All powders had a nominal particle size between 0.3-0.5 μm. The ceramic powder of the extrudate was a blend of 60 wt % NiO and 40 wt % of a mixture of BaSO₄, CeO₂, ZrO₂ and Y₂O₃ in molar ratios to yield BaZr_{0.7}Ce_{0.2}Y_{0.1}O_{3-δ}. The aqueous binder system included 60 wt. % water, 1 wt. % ammonium polyacrylate dispersant and 5 wt. % acrylic emulsion. The tubes were dried at room temperature while being rotated. After drying, the ceramic tube was then hangfired in a muffle furnace at a temperature of 1,650° C. for 15 hours (h). The subsequent reduction was done at 1,000° C. for 48 hours in a flow of 5% H₂ balanced with Ar.

The tubular Ni/BaZr_{0.7}Ce_{0.2}Y_{0.1}O_{3-δ} catalyst was implemented as the electrical resistance-heating catalyst for a steam methane reforming reaction. The catalyst tube was 5 centimeters (cm) long with an outer diameter of 0.96 cm and an inner channel diameter of 0.8 cm. The tube was assembled onto a 316 SS Swagelok-based system providing electrical contacts and feedthroughs for thermocouples and gases. To avoid steam condensation, all gas lines were preheated. Under 1 bara testing conditions, the gas was preheated to 110° C. Under 10 bara testing conditions, the gas was preheated to 230° C. With the exception of the preheating, all heat during testing conditions was supplied by resistance heating of the catalyst tube. The feed gas was a mixture of 71.5 vol. % CH₄ and 28.5 vol. % H₂O (steam-to-carbon ratio (S/C) of 2.5), under testing pressure of 1 or 10 bara. The flow of CH₄ was 75 mL min⁻¹, the GHSV was 638 mLg⁻¹h⁻¹ or 300 mLh⁻¹ cm⁻². The direct current (DC) was supplied from a power supply, and the voltage was recorded during the experiments.

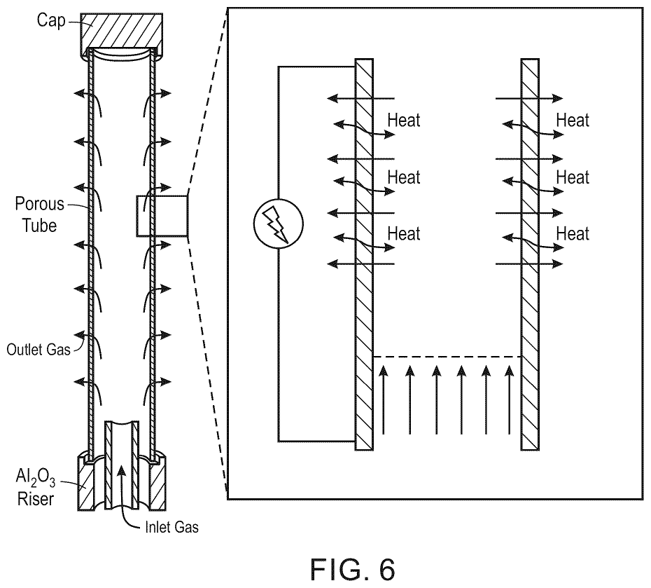

FIG. 6 shows an illustration of the experimental set up. The tubular Ni/BaZr_{0.7}Ce_{0.2}Y_{0.1}O_{3-δ} catalyst was placed on an alumina riser to maintain an appropriate configuration for the reactor set up assembly. A glass cap was placed atop the Ni/BaZr_{0.7}Ce_{0.2}Y_{0.1}O_{3-δ} catalyst to force the reactant gases go through catalyst tube. The tubular Ni/BaZr_{0.7}Ce_{0.2}Y_{0.1}O_{3-δ} catalyst was heated by electrical-resistance heating. Gas was flown through the inlet into an interior space of the tubular Ni/BaZr_{0.7}Ce_{0.2}Y_{0.1}O_{3-δ} catalyst and was able to pass through pores of the walls of the tubular Ni/BaZr_{0.7}Ce_{0.2}Y_{0.1}O_{3-δ} catalyst. The curved arrows represent heat radiating off the catalyst and the straight arrows represent the gas flow.

For experiments using a fixed bed reactor, the catalyst tube was crushed into 200-450 μm particles for the catalyst bed of the fixed bed reactor.

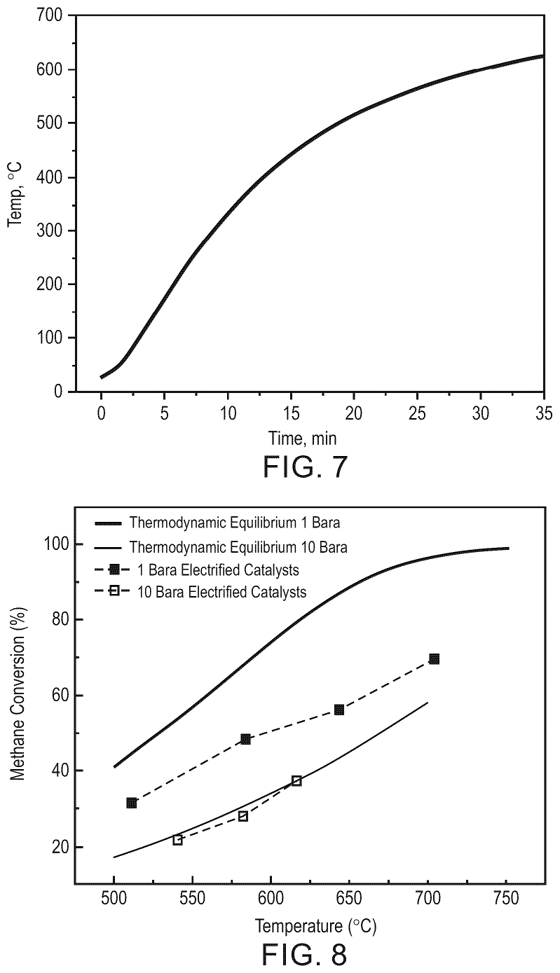

FIG. 7 shows the response time for the electrified catalysts. FIG. 7 shows that the catalysts can be very quickly electrically heated to the desired temperatures. The catalyst was heated from room temperature to 600° C. within 0.5 hours at a current of 40 A and a voltage of 2.4 V, representing a very fast start-up of the reactor. The temperature of the catalysts could be controlled by the electrical power supplied. By setting the current from 30 A to 60 A the temperature ranged from 500 to 750° C.

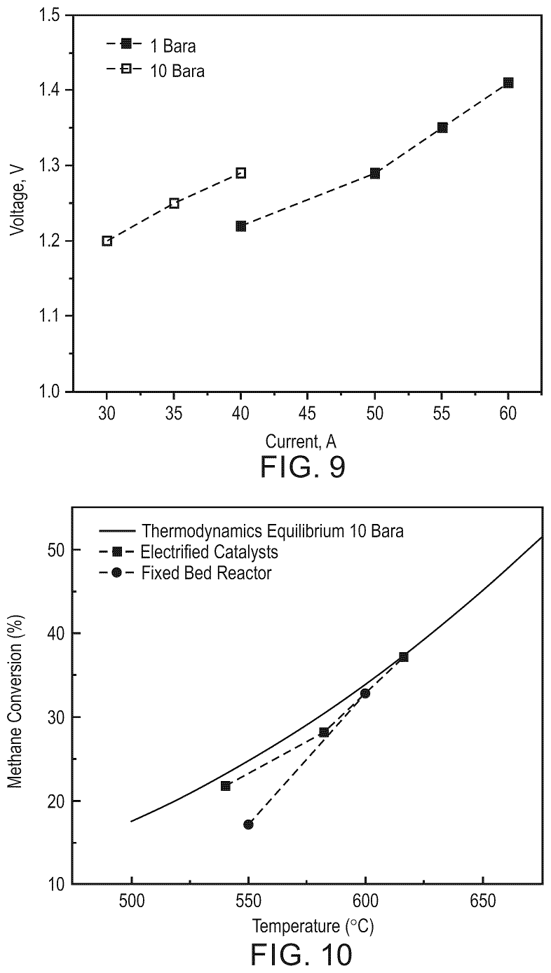

FIG. 8 shows experimental data for steam methane reforming testing results with electrical resistance-heating under 1 and 10 bara condition compared to the thermodynamic equilibrium plot. Experimental conditions were S/C 2.7, GHSV 638 mLg⁻¹h⁻¹, 355 mL h⁻¹cm⁻². Under 10 bara testing conditions, the methane conversion ratio was very close to the thermodynamic equilibrium, as shown in FIG. 8. Meanwhile, the methane conversion under 1 bara was much higher than that under 10 bara, based on the steam methane reforming thermodynamics. FIG. 9 shows the corresponding current and voltage from the experiments shown in FIG. 8.

FIG. 10 shows steam methane reforming testing results with electrical resistance-heating under 10 bara conditions compared to that of fixed bed reactor with the same materials. Experimental conditions were 10 bara, S/C 2.7, GHSV 638 mLg⁻¹h⁻¹, 355 mL h⁻¹cm⁻².

The resistance heating catalyst showed comparable or even superior methane conversion ratio than that of fixed bed reactor experiments, as shown in FIG. 10.

### EMBODIMENTS

1. A system, including:
a composite catalyst including:
   a porous metal oxide; and
   a catalytically active phase supported by the porous metal oxide; and
a power source configured to heat the composite catalyst by electrical resistance heating.

2. The system of embodiment 1, wherein the catalytically active phase is homogeneously distributed in the porous metal oxide.

3. The system of embodiment 1 or 2, wherein the catalytically active phase includes a member selected from the group consisting of Ni, Ru, Fe, Pt, and Pd.

4. The system of any one of embodiments 1-3, wherein the porous metal oxide includes a member selected from the group consisting of:
Y-doped BaZrO₃;
Y-doped BaCeO₃;
AZrₐCe_{b}B_{c}O_{3-δ}, wherein A is Ba, Sr, or Ca; B is Y, Yb, Pr, Gd, Fe, Co, Ni, Cu, or Zn; a+b+c equals 1; b is 0-0.95; c is 0.05-0.5; and 8 is a number such that formula is uncharged; and
XₐM1M2Oₓ, wherein M1 and M2 are Al, Si, Zr, Ce, Ti or Mg; M2 is different from M1; X is K, Ca or B; a is 0-1; and x is nonstoichiometric and can vary under different conditions.

5. The system of any one of embodiments 1-4, wherein the porous metal oxide includes BaZr_{0.7}Ce_{0.2}Y_{0.1}O_{3-δ}.

6. The system of any one of embodiments 1-5, wherein the composite catalyst includes Ni/BaZr_{0.7}Ce_{0.2}Y_{0.1}O_{3-δ}.

7. The system of any one of embodiments 1-6, wherein the composite catalyst has a porosity of 20% to 70%.

8. The system of any one of embodiments 1-7, wherein the composite catalyst has a total surface area of 20 m²/g to 100 m²/g.

9. The system of any one of embodiments 1-8, wherein the catalytically active phase has a surface area of 1 m²/g to 20 m²/g.

10. The system of any one of embodiments 1-9, wherein the catalytically active phase includes a member selected from the group consisting of nanoclusters and nanoparticles.

11. The system of any one of embodiments 1-10, wherein the composite catalyst includes 30 wt. % to 70 wt. % of the catalytically active phase.

12. The system of any one of embodiments 1-11, wherein the composite catalyst includes a tubular structure.

13. The system of embodiment 12, further including an inlet configured to deliver a gas to an interior space of the tubular structure.

14. The system of any one of embodiments 1-11, wherein the composite catalyst includes a honeycomb structure with a plurality of parallel channels.

15. The system of embodiment 14, wherein the honeycomb structure includes a first face and a second face;
a first portion of the parallel channels are sealed at the first face;
a second portion of the parallel channels are sealed at the second face; and
the second portion of the parallel channels is different from the first portion of the parallel channels.

16. The system of any one of embodiments 1-15, further including:
a pressure vessel; and
an insulation material,
wherein:
   the composite catalyst is disposed inside the pressure vessel; and
   the insulation material is between the pressure vessel and the composite catalyst.

17. A reformer plant including the system of any one of embodiments 1-15.

18. The reformer plant of embodiment 17, further including a membrane gas separation unit in fluid communication with an output of the system.

19. A method, including:
applying a current to a composite catalyst, thereby heating the composite catalyst;
contacting the heated composite catalyst with a first gas stream; and
forming a second gas stream,
wherein the composite catalyst includes:
   a porous metal oxide; and
   an active phase supported by the porous metal oxide.

20. The method of embodiment 19, wherein the first gas stream includes methane and water and the second gas stream includes hydrogen and carbon monoxide.

What is claimed:

1. A system, comprising:
a composite catalyst comprising:
a porous metal oxide; and
a catalytically active phase supported by the porous metal oxide; and
a power source configured to heat the composite catalyst by electrical resistance heating.

2. The system of claim 1, wherein the catalytically active phase is homogeneously distributed in the porous metal oxide.

3. The system of claim 1, wherein the catalytically active phase comprises a member selected from the group consisting of Ni, Ru, Fe, Pt, and Pd.

4. The system of claim 1, wherein the porous metal oxide comprises a member selected from the group consisting of:
Y-doped BaZrO₃;
Y-doped BaCeO₃;
AZrₐCe_{b}B_{c}O_{3-δ}, wherein A is Ba, Sr, or Ca; B is Y, Yb, Pr, Gd, Fe, Co, Ni, Cu, or Zn; a+b+c equals 1; b is 0-0.95; c is 0.05-0.5; and 8 is a number such that formula is uncharged; and
XₐM1M2Oₓ, wherein M1 and M2 are Al, Si, Zr, Ce, Ti or Mg; M2 is different from M1; X is K, Ca or B; a is 0-1; and x is nonstoichiometric and can vary under different conditions.

5. The system of claim 1, wherein the porous metal oxide comprises BaZr_{0.7}Ce_{0.2}Y_{0.1}O_{3-δ}.

6. The system of claim 1, wherein the composite catalyst comprises Ni/BaZr_{0.7}Ce_{0.2}Y_{0.1}O_{3-δ}.

7. The system of claim 1, wherein the composite catalyst has a porosity of 20% to 70%.

8. The system of claim 1, wherein the composite catalyst has a total surface area of 20 m²/g to 100 m²/g.

9. The system of claim 1, wherein the catalytically active phase has a surface area of 1 m²/g to 20 m²/g.

10. The system of claim 1, wherein the catalytically active phase comprises a member selected from the group consisting of nanoclusters and nanoparticles.

11. The system of claim 1, wherein the composite catalyst comprises 30 wt. % to 70 wt. % of the catalytically active phase.

12. The system of claim 1, wherein the composite catalyst comprises a tubular structure.

13. The system of claim 12, further comprising an inlet configured to deliver a gas to an interior space of the tubular structure.

14. The system of claim 1, wherein the composite catalyst comprises a honeycomb structure with a plurality of parallel channels.

15. The system of claim 14, wherein the honeycomb structure comprises a first face and a second face;
a first portion of the parallel channels are sealed at the first face;
a second portion of the parallel channels are sealed at the second face; and
the second portion of the parallel channels is different from the first portion of the parallel channels.

16. The system of claim 1, further comprising:
a pressure vessel; and
an insulation material,
wherein:
the composite catalyst is disposed inside the pressure vessel; and
the insulation material is between the pressure vessel and the composite catalyst.

17. A reformer plant comprising the system of claim 1.

18. The reformer plant of claim 17, further comprising a membrane gas separation unit in fluid communication with an output of the system of claim 1.

19. A method, comprising:
applying a current to a composite catalyst, thereby heating the composite catalyst;
contacting the heated composite catalyst with a first gas stream; and
forming a second gas stream,
wherein the composite catalyst comprises:
a porous metal oxide; and
an active phase supported by the porous metal oxide.

20. The method of claim 19, wherein the first gas stream comprises methane and water and the second gas stream comprises hydrogen and carbon monoxide.
